(19) United States
(12) Patent Application Publication
(10) Pub. No.: US 2006/0104226 A1
(43) Pub. Date: May 18, 2006

(54) IPv4-IPv6 transition system and method using dual stack transition mechanism(DTSM)

(76) Inventor: Joong-Kyu Ahn, Anyang-si (KR)

Correspondence Address: Robert E. Bushnell, Suite 300, 1522 K Street, N.W., Washington, DC, 20005-1202, US

(21) Appl. No.: 11/271,868

(22) Filed: Nov. 14, 2005

(30) Foreign Application Priority Data
Nov. 15, 2004 (KR) 2004-93281

(51) Int. Cl. H04J 3/08; H04B 7/14; H04J 1/10

(52) U.S. Cl. 370/315

(57) ABSTRACT

An IPv4-IPv6 transition method using a Dual Stack Transition Mechanism (DTSM) includes: setting a Domain Name System (DNS) between a DSTM client and a DSTM server arranged in an IPv6 network and a TEP/DNSv4 connected to the IPv4 network to perform V4 domain name processing; transmitting a DNS searching request for the DSTM client to be connected to the DNSv4 server in the IPv4 network from a V4HOST positioned in the IPv4 network to the DNSv4 server; obtaining, by the DNSv4 server, the IPv4 address of the DSTM client by communicating with the TEP/DNSv4, and transferring the IPv4 address to the V4HOST; and connecting, by the V4HOST, to the DSTM client using the obtained IPv4 address.

### CLAIM OF PRIORITY

This application makes reference to, incorporates the same herein, and claims all benefits accruing under 35 U.S.C. §119 from an application for IPv4-IPv6 TRANSITION SYSTEM AND METHOD USING DUAL STACK TRANSITION MECHANISM earlier filed in the Korean Intellectual Property Office on 15 Nov. 2004 and there duly assigned Serial No. 2004-093281.

### BACKGROUND OF THE INVENTION

1. Field of the Invention

The present invention relates to an IPv4-IPv6 transition mechanism, and more specifically, to an IPv4-IPv6 transition system and method using a dual stack transition mechanism, in which the unidirectionality of a Dual Stack Transition Mechanism (DSTM) as one of 4in6 mechanisms can be overcome, and a node in an IPv4 network can be connected to a node in an IPv6 network.

2. Description of the Related Art

Currently, a primary network layer protocol in a Transmission Control Protocol/Internet Protocol (TCP/IP) group is an Internet Protocol version 4 (IPv4). The IPv4 provides a host-to-host communication between systems over the Internet.

Although the IPv4 was well designed, data communication has been continuously developed since 1970 when IPv4 entered the market, and IPv4 defects have started to be gradually discovered, these defects rendering it unsuitable for rapid Internet development.

IPv4 has a 2-level address structure consisting of five classes, and there is an inefficiency in this address arrangement. The address assigning method of IPv4 has a problem in that it will exhaust the address space and therefore no addresses will remain to be assigned to new systems needing an Internet connection.

Furthermore, the Internet has to accommodate real-time audio and video transmission, but such transmissions requires a minimum delay strategy and a resource reservation. Real-time audio and video transmission also needs data encryption and authentication in some Internet application fields, which are not provided in IPv4.

In order to overcome such defects, Internet Protocol version 6 (IPv6), also known as Internetworking Protocol next generation (IPng), has been suggested and has become a standard. Most of the Internet Protocol in IPv6 was amended to accommodate the Internet that is under rapid development. The format and length of an IP address has been changed along with a packet format. Related protocols, such as the Internet Control Message Protocol (ICMP), were also amended. Other protocols, such as the Address Resolution Protocol (ARP), Reverse Address Resolution Protocol (RARP) and Internet Group Management Protocol (IGMP), were also deleted or included in the ICMP. Routing protocols, such as Routing Information Protocol (RIP) and Open Shortest Path First (OSPF), were also amended to accommodate such a change.

The following summary can be obtained from comparison of the merit of IPv6 as a next generation IP to that of IPv4:

First, the IPv6 address has a length of 128 bits, which has an expanded address space compared with the IPv4 address of 32 bits.

Second, IPv6 has options separated from a base header and uses a new format in which the header is inserted between a base header and upper layer data, if necessary. This allows most options to not be tested by a router, thus simplifying and making a routing procedure faster.

Third, IPv6 has a new option permitting an additional function.

Fourth, IPv6 was designed to permit the extension of the protocol required in a new technology or application field.

Fifth, in IPv6, a type of service field has deleted and a mechanism referred to as a flow label added, so that a sender can request a special process for a packet. Such a mechanism can be used in providing traffic such as real time audio and video.

Sixth, the encryption and authentication options in the IPv6 provide reliability and integrity of the packet.

Despite the problems of IPv4 described above, there are so many existing systems sill using IPv4 that it will take a long time to migrate from IPv4 to IPv6. Under such a situation, there are many kinds of strategies related to a transition mechanism between IPv6 and IPv4. The strategies can be largely classified into a 6in4 mechanism in which IPv6 data is loaded into an IPv4 format packet and a 4in6 mechanism in which IPv4 data is loaded into an IPv6 format packet.

Examples of representative transition mechanisms include a dual stack, tunneling, a header transition, and the like.

Tunneling is a strategy used when two computers using IPv6 have to pass a region where IPv4 is used to communicate with each other. In order to pass the region, each packet has to have an IPv4 address. An IPv6 packet is encapsulated in an IPv4 packet when entering the region and decapsulated when coming out of the region. This is comparable to a situation where an IPv6 packet enters into one side of a tunnel and comes out the other side.

The header translation is needed when some systems use IPv4 while most of Internet systems use IPv6. When a receiver cannot recognize IPv6 even though a sender wishes to use IPv6, each packet must be in the IPv6 format to be recognized by the receiver, so that the tunneling does not operate under such a situation. In this case, the header format must be totally changed through the header translation. The header of an IPv6 packet is translated into an IPv4 header using a map address.

A Dual Stack Transition Mechanism (DSTM) is a method in which all hosts have a dual stack protocol before they are transferred to a version 6, and dynamic tunneling is performed using the 4in6. The dual stack node (hereinafter referred to as a “DSTM client”) in an IPv6-only network executes the IPv4 application so that it communicates with an IPv4 node of the IPv4 network.

In using the dual stack, an originating host makes an inquiry of a Domain Name System (DNS) to determine a version that should be used when transmitting the packet to a destination. The originating host transmits IPv4 packets when the DNS responds to an IPv4 address and IPv6 packets when the DNS responds to an IPv6 address.

An advantage of this technology is that the use of a global IPv4 address can be reduced and the management of the network is relatively simple since the DSTM client can communicate with an IPv4 node after obtaining a temporary IPv4 address.

The DSTM is composed of three components. The first component is a DSTM client in the IPv6-only network, and the second is a DSTM server that manages an IPv4 address pool. The DSTM server assigns a temporary global IPv4 address that the DSTM client is able to use. The third component is a DSTM border router referred to as a DSTM gateway or Tunnel End Point (TEP) for encapsulating and decapsulating an IPv4 over an IPv6 packet.

In general, a DSTM is composed of a DSTM client, a DSTM server, a TEP and a V4HOST.

If the DSTM client of an IPv6-only network attempts to begin communicating with a node D of an IPv4 network, it first requests the DSTM server to assign a temporary IPv4 address. The DSTM server then assigns a temporary IPv4 address for a node A, informs the node A of the assigned IPv4 address, address information of the TEP and lifetime of the assigned IPv4 address, and also transfers corresponding information to the TEP.

The DSTM client that has received the information from the DSTM server initializes its own IPv4 stack, encapsulates the IPv4 packet into IPv6 and transfers it to the TEP. The TEP decapsulates the packet and forwards the decapsulated packet to the V4HOST. The packet transferred to the DSTM client from the V4HOST is transferred to the TEP, and is then IPv6-encapsulated and transferred to the DSTM client.

The DTSM described above is useful when a packet is transferred from a specific node in an IPv6-only network to a node in an IPv4 network, but does not work when it is necessary to transfer the packet in a reverse direction.

That is, although it is necessary to recognize an address of a node in the IPv6 network in order to transfer the packet from a specific node in the IPv4 network to a node in the IPv6 network, the corresponding node does not have an IPv4 address. Furthermore, even if an IPv4 address of the corresponding node exists, a problem occurs in transferring the packet from the specific node in the IPv4 network to the specific node in the IPv6 network since an originating node in the IPv4 network cannot recognize the address of such a temporarily assigned IPv4.

### SUMMARY OF THE INVENTION

It is, therefore, an object of the present invention to provide an IPv4-IPv6 transition system and method using a DSTM, which enables an access from a node in an IPv4 network to a node in an IPv6 network by realizing a connection through the IPv4 using a DSTM when a dual stack node (a DSTM client) of the IPv6-only network is a server.

According to one aspect of the present invention, an IPv4-IPv6 transition method using a Dual Stack Transition Mechanism(DTSM) to communicate between an Internet Protocol version 6 (IPv6) network and an Internet Protocol version 4 (IPv4)network is provided, the method comprising: performing V4 domain name processing by setting a Domain Name System (DNS) between a DSTM client and a DSTM server arranged in a IPv6 network and a Tunnel End Point (TEP)/DNSv4 connected to a IPv4 network; transmitting a DNS searching request for the DSTM client to be connected to a DNSv4 server in the IPv4 network from a V4HOST arranged in the IPv4 network to the DNSv4 server; obtaining an IPv4 address of the DSTM client by communication between the DNSv4 server and the TEP/DNSv4, and transferring the obtained IPv4 address to the V4HOST; and connecting the V4HOST to the DSTM client using the obtained IPv4 address.

Connecting the V4HOST to the DSTM client preferably comprises: analyzing the IPv4 packet transferred from the TEP/DNSv4; locating an address in the IPv6 network by searching an IPv4-IPv6 mapping table; and connecting to the DSTM client of a corresponding address.

Setting the DNS preferably comprises: transmitting a tunnel generation message from the DSTM client to the DSTM server; loading client information and domain name obtained from the tunnel generation message and information including a V4 address selected from a V4 address pool on a new tunnel generation message in the DSTM server and transmitting the information to the TEP/DNSv4; and recording the received client information in the TEP/DNSv4, generating a tunnel information message indicating that tunnel generation has been completed, and transmitting the information message to the DSTM client via the DSTM server.

The tunnel generation message transmitted to the DSTM server by the DSTM client preferably comprises at least one of information on an IPv6 address, a host name and a domain name of the DSTM client.

The tunnel generation message transmitted to the TEP/DNSv4 by the DSTM server preferably comprises at least one of information on an IPv6 link-local address, an IPv6 global address, a host name, and a domain name of the DSTM client, and information on the V4 address selected by the DSTM server to be matched with the domain name in the IPv4 address pool.

Information on an IPv4 address pool to be used in the DSTM domain, a domain name corresponding to the IPv4 address pool, and an address of the TEP, and corresponding information set by a system manager is preferably stored in the DSTM server.

The TEP/DNSv4 preferably manages TEP data, processes a tunnel message, connects to a V4 domain to process a V4 domain name, and controls a routing process function for setting V4 routing and V6 routing.

The TEP data preferably comprises an IPv4-IPv6 mapping table, the table including at least one of information on a V6 address, a V4 address, a host name and a lifetime in each DSTM domain.

The method preferably further comprises: obtaining information on an IPv4 address pool to be used in the DSTM domain, a domain name corresponding to the IPv4 address pool and an address of the TEP, with the DSTM server and setting a DNSv4 address of the domain name managed by the DSTM server to an address of the TEP with the DNSv4, prior to setting the DNS.

According to another aspect of the present invention, an IPv4-IPv6 transition system using a Dual Stack Transition Mechanism(DTSM) to communicate between an Internet Protocol version 6 (IPv6) network and an Internet Protocol version 4 (IPv4)network is provided, the transition system comprising: a DSTM client adapted to communicate with a node within an external IPv4 network using a 4in6 tunnel in the IPv6 network; a DSTM server adapted to manage information on an IPv4 address pool, a domain name corresponding to the IPv4 address pool, and an address of a Tunnel End Point (TEP); and a TEP/DNSv4 adapted to encapsulate a packet transferred from the IPv4 network and to transmit the packet to the IPv6 network, and to decapsulate the packet transmitted from the IPv6 network via the DSTM client and the DSTM server and to transmit the packet to the IPv4 network.

The system preferably further comprises: a V4HOST arranged in the IPv4 network and adapted to try to connect to a server within the IPv6 network; and a DNSv4 adapted to obtain an IPv4 address of the DSTM client via communication with the TEP/DNSv4 and to transmit the obtained IPv4 address to the V4HOST; wherein the V4HOST is connected to the DSTM client by the TEP/DNSv4 using the obtained IPv4 address.

The TEP/DNSv4 preferably includes: a TEP process adapted to manage TEP data and to process a tunnel message; a DNSv4 server connected to a V4 domain to perform a V4 domain name process; and a routing process adapted to set V4 routing and V6 routing.

The TEP data is preferably arranged in an IPv4-IPv6 mapping table structure, and preferably includes at least one of information on a V6 address, a V4 address, a host name and a lifetime in each DSTM domain.

A Domain Name System (DNS) is preferably set by exchanging a tunnel generation message and a tunnel information message between the DSTM client, the DSTM server and the TEP/DNSv4.

The DNS setting preferably comprises: enabling the DSTM client to transmit a tunnel generation message to the DSTM server; enabling the DSTM server to load client information and domain name obtained from the tunnel generation message and information including a V4 address selected from a V4 address pool on a new tunnel generation message and to transmit the information to the TEP/DNSv4; and enabling the TEP/DNSv4 to record the received client information, generate a tunnel information message indicating that tunnel generation has been completed, and to transmit the information message to the DSTM client via the DSTM server.

The tunnel generation message transmitted to the DSTM server by the DSTM client preferably includes at least one of information on an IPv6 address, a host name and a domain name of the DSTM client.

The tunnel generation message transmitted to the TEP/DNSv4 by the DSTM server preferably includes at least one of information on an IPv6 link-local address, an IPv6 global address, a host name, and a domain name of the DSTM client, and information on the V4 address selected by the DSTM server to be matched with the domain name in the IPv4 address pool.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a view of a DSTM structure;

FIG. 2 is a view of a DSTM construction applied to the present invention;

FIG. 3 is a view of a data structure managed by a DSTM server in accordance with an embodiment of the present invention;

FIG. 4 is a view of a TEP/DNSv4 structure in accordance with an embodiment of the present invention;

FIG. 5 is a view of a data structure of a TEP in accordance with an embodiment of the present invention;

FIG. 6 is a view of a message flow in accordance with an embodiment of the present invention;

FIG. 7 is a view of an embodiment of a tunnel generation message transmitted to the DSTM server by the DSTM client;

FIG. 8 is a view of an embodiment of the tunnel generation message transmitted to the TEP/DNSv4 by the DSTM server; and

FIG. 9 is a view of an embodiment of a tunnel information message transmitted to the DSTM server and DSTM client by the TEP/DNSv4.

### DETAILED DESCRIPTION OF THE INVENTION

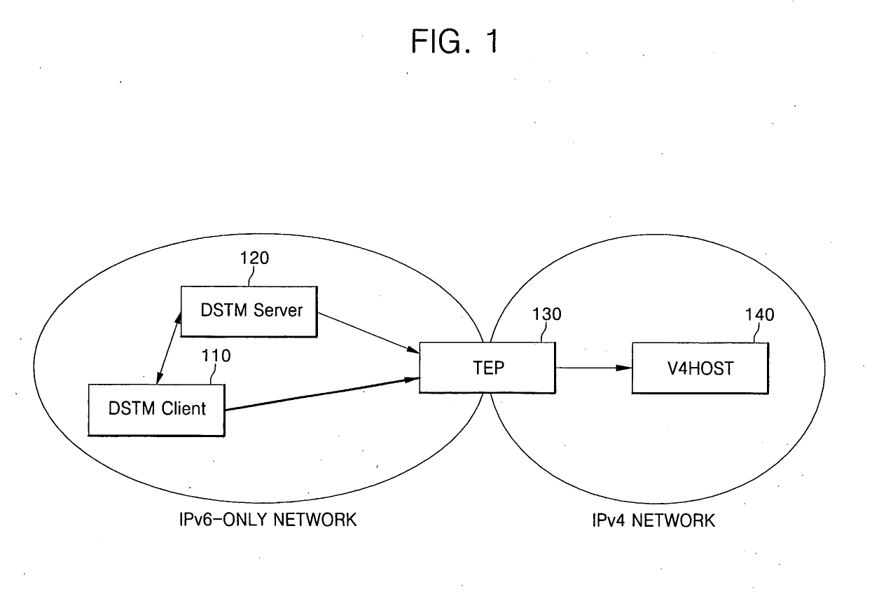

FIG. 1 is a view of a DSTM structure. The DSTM is composed of a DSTM client 110, a DSTM server 120, a TEP 130 and a V4HOST 140.

If the DSTM client 110 of an IPv6-only network attempts to begin communicating with a node D of an IPv4 network, it first requests the DSTM server 120 to assign a temporary IPv4 address. The DSTM server 120 then assigns an temporary IPv4 address for a node A, informs the node A of the assigned IPv4 address, address information of the TEP and lifetime of the assigned IPv4 address, and also transfers the corresponding information to the TEP 130.

The DSTM client 110 that has received the information from the DSTM server 120 initializes its own IPv4 stack, encapsulates the IPv4 packet into IPv6 and transfers it to the TEP 130. The TEP 130 decapsulates the packet and forwards the decapsulated packet to the V4HOST 140. The packet transferred to the DSTM client 110 from the V4HOST 140 is transferred to the TEP 130, and is then IPv6-encapsulated and transferred to the DSTM client 110.

The present invention will now be described more fully hereinafter with reference to the accompanying drawings, in which exemplary embodiments of the present invention are shown. The present invention can, however, be embodied in different forms and should not be construed as being limited to the embodiments set forth herein. Rather, these embodiments are provided so that this disclosure will be thorough and complete, and will fully convey the scope of the present invention to those skilled in the art. Like numbers refer to like elements throughout the specification.

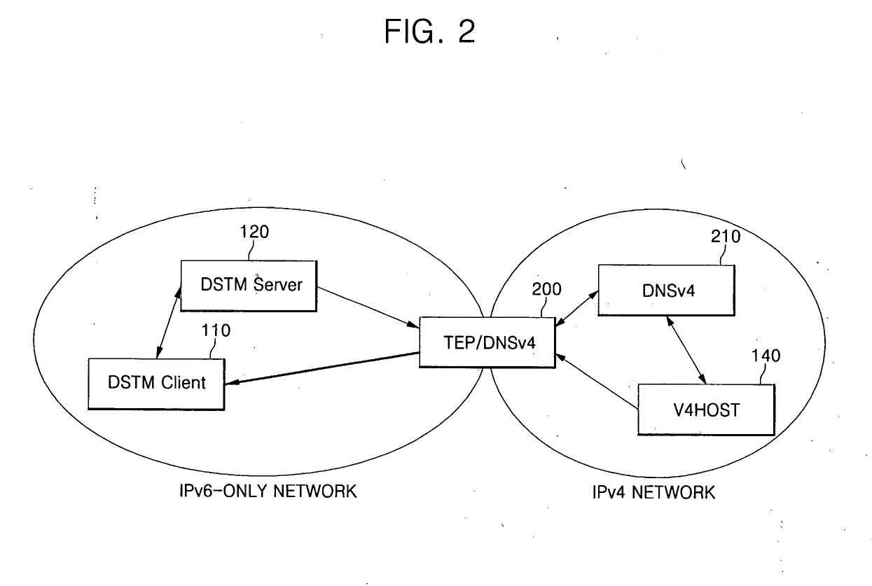

FIG. 2 is a view of a DSTM construction applied to the present invention.

A DSTM client 110 serves to communicate with an external IPv4 node in a DSTM domain using the 4in6 tunneling mechanism. The DSTM client must be aware of its domain name and host name in order to function as IPv4 server.

The DSTM server 120 serves to assign an arbitrary IPv4 address to the DSTM client 110. To do that, the DSTM server 120 must maintain and manage its IPv4 address pool information, domain name information on the address pool, information on a DSTM border router for the address pool, and IPv4 information assigned to a current DSTM client.

A TEP/DNSv4 200 serves as the DSTM border router. It decapsulates the 4in6 packet transferred in a DSTM domain and transfers the packet to the IPv4 network, and encapsulates the IPv4 packet transferred in the IPv4 network into 4in6 packet and transfers the packet to the DSTM domain.

A V4HOST 140 is a host existing in the IPv4 network, and can be regarded as an originator of the 4in6 mechanism to be embodied in the present invention.

A DSNv4 210 is a DNS server to process a packet transmitted from the IPv4 network to the IPv6 network, and performs the same role as the DNS server that is generally used in the IPv4 network.

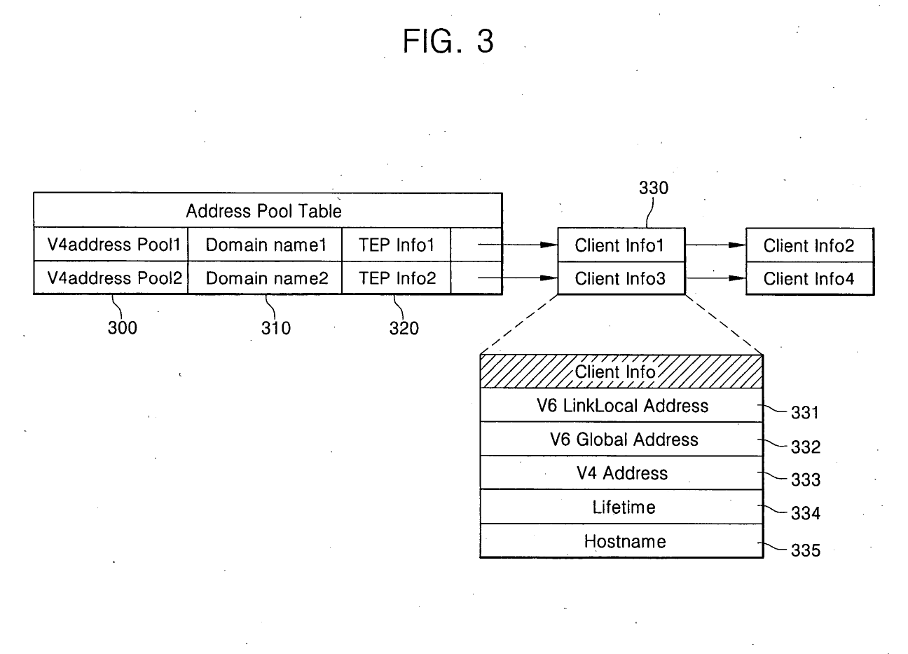

FIG. 3 is a view of a data structure managed by a DSTM server in accordance with an embodiment of the present invention.

FIG. 3 indicates two V6 domains, each domain having a domain name 310, TEP information 320 and client information 330 according to the V4 address pool 300.

Each of the client information 330 includes a V6 link local address 331, a V6 global address 332, a V4 address 333, a lifetime 334, and a host name 335.

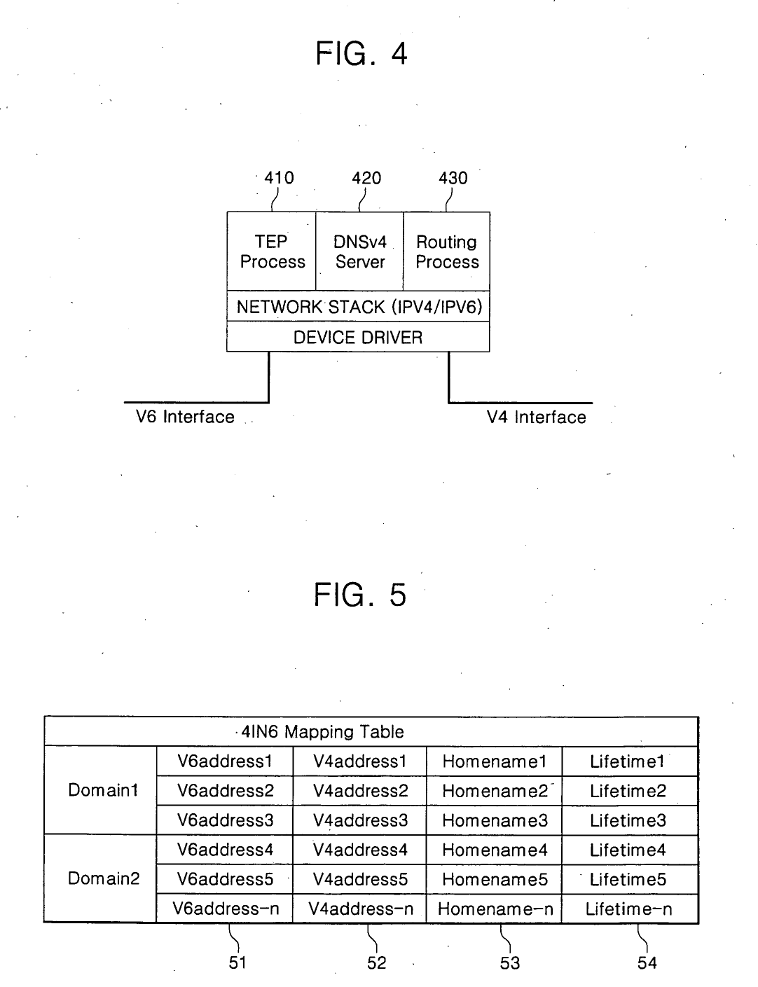

FIG. 4 is a view of a TEP/DNSv4 structure in accordance with an embodiment of the present invention.

The TEP/DNSv4 in accordance with an embodiment of the present invention has at least two V6/V4 interfaces in order to connect the DSTM domain (IPv6 domain) to the IPv4 domain. The interface is connected to an upper layer through a device driver and a network stack, the upper layer including a TEP process 410, a DSNv4 server 420, and a routing process 430.

That is, the TEP/DNSv4 includes a routing process 430 for setting routings of V4 (including a static routing) and V6, a DNSv4 server 420 for processing V4 DNS, and a TEP 410 for performing a function of an existing DSTM border router to process the tunnel message.

The Tunnel End Point (TEP), being a process of the present invention, must have an ability to process query/reply for a minimal DNSv4, and basic information for such a process is shown in FIG. 5.

FIG. 5 is a view of a data structure of a TEP in accordance with an embodiment of the present invention.

Data managed by the TEP is included in an IPv4-IPv6 mapping table structure, and connects the V6 domain to V4 domain. If it is assumed that there are two V6 domains in the embodiment of FIG. 5 as in the example of FIG. 3, the domains have V6 addresses 51, and V4 addresses 52, host names 53 and lifetime 54 matched to each of the V6 addresses, as corresponding information.

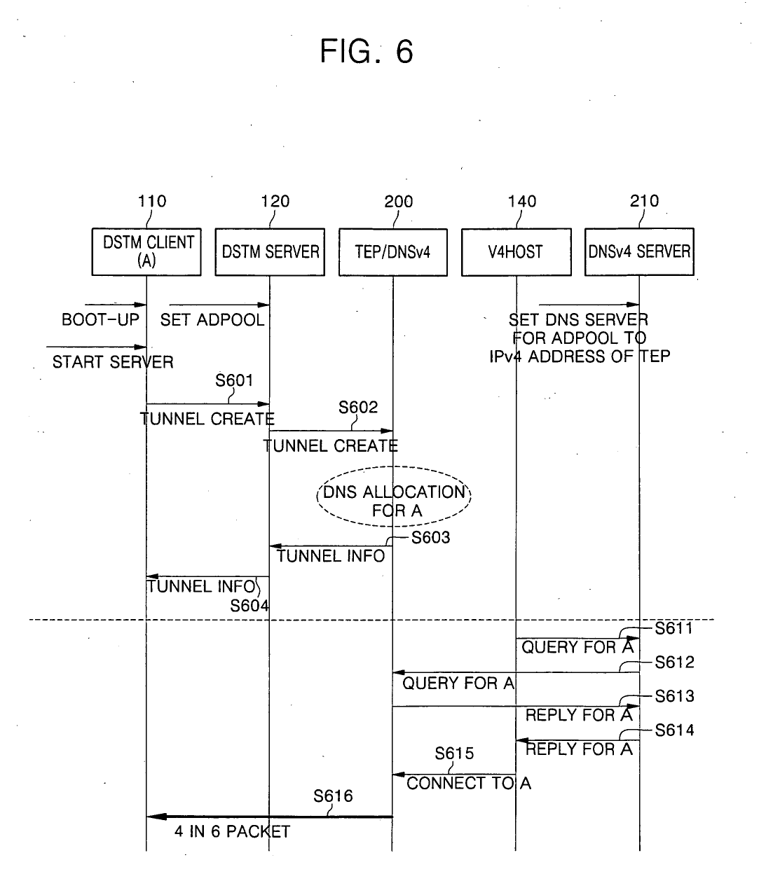

FIG. 6 is a view of a message flow in accordance with an embodiment of the present invention.

The process of FIG. 6 is divided into a basic setup process for DNS and a process where a host of the IPv4 network tries to connect to a DSTM client.

At first, the preparation to be made in each apparatus prior to beginning the primary procedure in accordance with an embodiment of the present invention is as follows.

The DSTM server 120 must have information on the IPv4 ADdress POOL (ADPOOL) to be used in the DSTM domain, a domain name corresponding to the IPv4 address pool, and address information of the TEP, which can be set up by a system manager. Also, the DNSv4 server 210 of the IPv4 network sets up an address of the DNSv4 of the domain name managed by the DSTM server 120 as an address of the TEP.

A basic setup procedure for the DNS is as follows.

The DSTM client 110 has an IPv6 address when booting up for the first time, and transfers information on its IPv6 address, a host name, a domain name and the like to the DSTM server 120 using a Tunnel Create message (Tunnel Create) when the DSTM client operates as a server (S601).

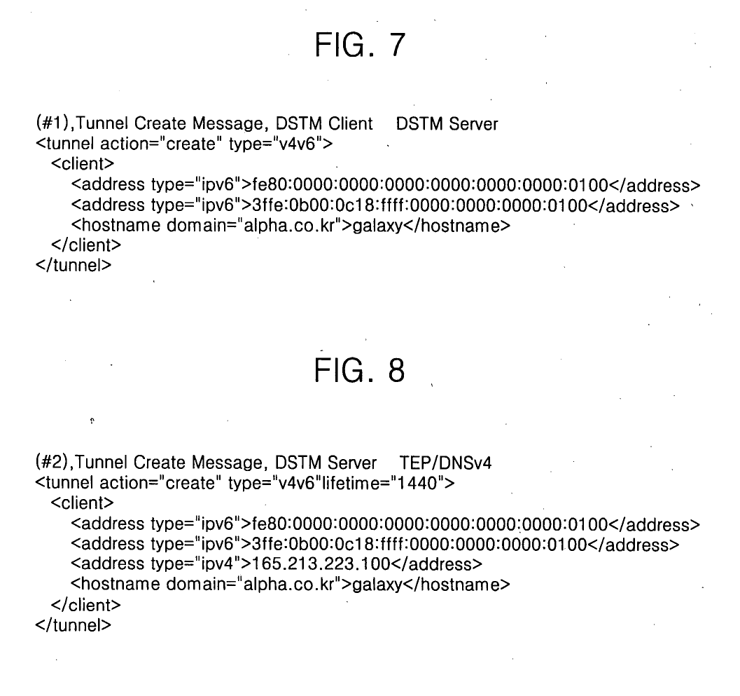

FIG. 7 is a view of an exemplary embodiment of a tunnel generation message transmitted to the DSTM server by the DSTM client.

Referring to FIG. 7, the DSTM client 110 generates a message including a host name, ‘galaxy’ which has an IPv6 link-local address ‘fe80:0000 . . . ’, an IPv6 global address ‘3ffe:0b00: . . . ’, a domain name ‘alpha.co.kr’ as its information, and transfers the message to the DSTM server 120.

The DSTM server 120 that has received the tunnel generation message searches for the V4 address pool 300 and TEP information 320 corresponding to the domain name 310 referred to as ‘alpha.co.kr’ of address information sent by the client in the data structure of the DSTM server suggested in FIG. 3, and records them in the client information 330.

That is, the DSTM server 120 that has received the tunnel generation message selects one corresponding to the domain name from its own address pool table among the IPv4 address pool, and then records the one in a data structure managed by the DSTM server.

The DSTM server 120 that has completed the above procedure loads information including the client information 330 obtained from the tunnel generation message, the domain name 310 and one V4 address obtained from the V4 address pool on a new tunnel message, and transmits the information to the TEP/DNSv4 200 (S602).

FIG. 8 is a view of an exemplary embodiment of the tunnel generation message transmitted to the TEP/DNSv4 by the DSTM server.

Referring to FIG. 8, a V4 address selected in the V4 address pool 300 by the DSTM server 120 and transmitted to the TEP/DNSv4 200 is ‘165.213.223.100’.

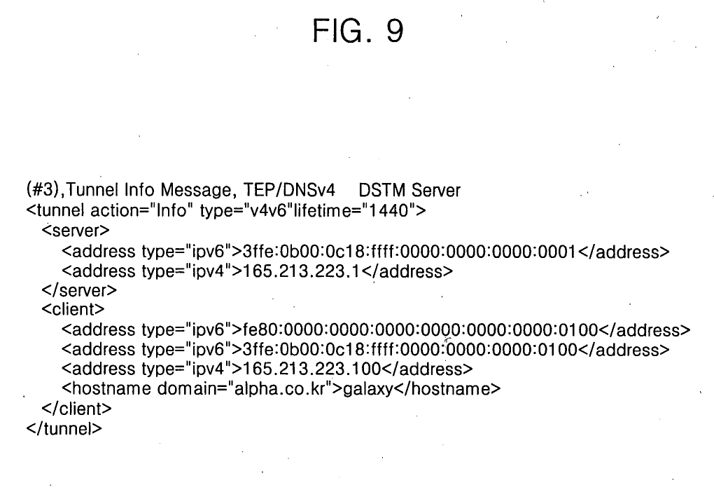

The TEP/DSNv4 200 receives a tunnel generation message such as the message of FIG. 7 from the DSTM server 120, records the message in the IPv4-IPv6 mapping table reviewed in FIG. 5, and responds to the DSTM server 120 using a tunnel information message (S603). The information is transmitted to the DSTM client 110 (S604), thereby completing the basic setup procedure for the DNS. A more detailed description follows with reference to FIGS. 8 and 9.

FIG. 9 is a view of an exemplary embodiment of a tunnel information message transmitted to the DSTM server and DSTM client by the TEP/DNSv4.

The TEP/DNSv4 200 records client information on the TEP data structure as shown in FIG. 5, generates tunnel information message as shown in FIG. 9 indicating that the tunnel generation has been completed, and transmits the message to the DSTM server 120. “165.213.223.1” of the IPv4 is a V4 address connected to the V4 domain of the TEP, and “3ffe:0b00:0c18:ffff::1” is an IPv6 address of the TEP/DNSv4 connected to the DSTM domain.

The DSTM server 120 that has received the message of FIG. 9 generates a tunnel information message indicating that the tunnel generation has been completed and transmits the message to the DSTM client 110 (S604). A format of the message is the same as the message format of FIG. 9 transmitted to the DSTM server 120 by the TEP/DNSv4 200.

A procedure where a host of the IPv4 network tries to connect to the DSTM client is as follows.

At first, one V4HOST 140 of the IPv4 network transmits a DNS search (Query) for the DSTM client 110 to which the host 140 wishes to connect, to the DNSv4 server 210 (S611). The DNSv4 server 210 obtains the IPv4 address of the DSTM client 110 by performing search and response (Query/Reply) with the TEP/DNSv4 200 (S612 and S613), and then transfers the IPv4 address to the V4HOST 140 (S614).

The V4HOST 140 tries to connect to the TEP/DNSv4 200 using the obtained IPv4 address (S615). The TEP/DNSv4 200 searches for its own IPv4-IPv6 mapping table by analyzing the received IPv4 packet, and transfers the 4in6 packet to the corresponding DSTM client 110 (S616).

In a subsequent transmission and reception procedure, a communication between the V4HOST 140 and the DSTM client 110 is performed using the 4in6 packet through the TEP/DNSv4 200.

The message flow in accordance with an embodiment of the present invention that is described through FIGS. 6 to 9 can be summarized as follows.

The DSTM client 110 has the IPv6 address upon initial booting, and transmits information on its IPv6 address, a host name, and a domain name to the DSTM server 120 using the tunnel generation message (Tunnel Create) when it is needed that the DSTM client operates as a server (S601).

The DSTM server 120 that has completed the above procedure loads information including the client information 330 obtained from the tunnel generation message, the domain name 310 and one V4 address obtained from the V4 address pool on a new tunnel message, and transmits the information to the TEP/DNSv4 200 (S602).

The TEP/DSNv4 200 receives a tunnel generation message from the DSTM server 120, records the message in the IPv4-IPv6 mapping table, and responds to the DSTM server 120 using tunnel information message (S603). The tunnel information is transmitted to the DSTM client 110 (S604), thereby completing the basic setup procedure for the DNS.

A procedure where one host of the IPv4 network tries to connect to the DSTM client after the basic setup procedure for the DNS is as follows.

One V4HOST 140 of the IPv4 network transmits a DNS search (Query) for the DSTM client 110 to which the host 140 wishes to connect, to the DNSv4 server 210 (S611). The DNSv4 server 210 obtains the IPv4 address of the DSTM client 110 by performing search and response (Query/Reply) with the TEP/DNSv4 200 (S6 12 and S6 13), and then transfers the IPv4 address to the V4HOST 140 (S614). The V4HOST 140 tries to connect to the TEP/DNSv4 200 using the obtained IPv4 address (S615), and the TEP/DNSv4 200 searches for its own IPv4-IPv6 mapping table by analyzing the received IPv4 packet and transfers the 4in6 packet to the corresponding DSTM client 110 (S616).

The present invention has an advantage in that a host in the IPv4 network can try to connect to the DSTM client within the DSTM domain through implementation of basic search and response functions for the DNSv4 in the TEP, and a connection to the IPv4 network can be performed through a host name without adding separate DNSv6 or DNS-ALG by enabling the TEP/DNSv4 to perform search and response for the DNSv4 using the 4in6 mechanism.

What is claimed is:

1. An IPv4-IPv6 transition method using a Dual Stack Transition Mechanism(DTSM) to communicate between an Internet Protocol version 6 (IPv6) network and an Internet Protocol version 4 (IPv4)network, the method comprising:
performing V4 domain name processing by setting a Domain Name System (DNS) between a DSTM client and a DSTM server arranged in a IPv6 network and a Tunnel End Point (TEP)/DNSv4 connected to a IPv4 network;
transmitting a DNS searching request for the DSTM client to be connected to a DNSv4 server in the IPv4 network from a V4HOST arranged in the IPv4 network to the DNSv4 server;
obtaining an IPv4 address of the DSTM client by communication between the DNSv4 server and the TEP/DNSv4, and transferring the obtained IPv4 address to the V4HOST; and
connecting the V4HOST to the DSTM client using the obtained IPv4 address.

2. The method according to claim 1, wherein connecting the V4HOST to the DSTM client comprises:
analyzing the IPv4 packet transferred from the TEP/DNSv4;
locating an address in the IPv6 network by searching an IPv4-IPv6 mapping table; and
connecting to the DSTM client of a corresponding address.

3. The method according to claim 1, wherein setting the DNS comprises:
transmitting a tunnel generation message from the DSTM client to the DSTM server;
loading client information and domain name obtained from the tunnel generation message and information including a V4 address selected from a V4 address pool on a new tunnel generation message in the DSTM server and transmitting the information to the TEP/DNSv4; and
recording the received client information in the TEP/DNSv4, generating a tunnel information message indicating that tunnel generation has been completed, and transmitting the information message to the DSTM client via the DSTM server.

4. The method according to claim 3, wherein the tunnel generation message transmitted to the DSTM server by the DSTM client comprises at least one of information on an IPv6 address, a host name and a domain name of the DSTM client.

5. The method according to claim 3, wherein the tunnel generation message transmitted to the TEP/DNSv4 by the DSTM server comprises at least one of information on an IPv6 link-local address, an IPv6 global address, a host name, and a domain name of the DSTM client, and information on the V4 address selected by the DSTM server to be matched with the domain name in the IPv4 address pool.

6. The method according to claim 1, wherein information on an IPv4 address pool to be used in the DSTM domain, a domain name corresponding to the IPv4 address pool, and an address of the TEP, and corresponding information set by a system manager is stored in the DSTM server.

7. The method according to claim 1, wherein the TEP/DNSv4 manages TEP data, processes a tunnel message, connects to a V4 domain to process a V4 domain name, and controls a routing process function for setting V4 routing and V6 routing.

8. The method according to claim 7, wherein the TEP data comprises an IPv4-IPv6 mapping table, the table including at least one of information on a V6 address, a V4 address, a host name and a lifetime in each DSTM domain.

9. The method according to claim 1, further comprising: obtaining information on an IPv4 address pool to be used in the DSTM domain, a domain name corresponding to the IPv4 address pool and an address of the TEP, with the DSTM server and setting a DNSv4 address of the domain name managed by the DSTM server to an address of the TEP with the DNSv4, prior to setting the DNS.

10. An IPv4-IPv6 transition system using a Dual Stack Transition Mechanism(DTSM) to communicate between an Internet Protocol version 6 (IPv6) network and an Internet Protocol version 4 (IPv4)network, the transition system comprising:
a DSTM client adapted to communicate with a node within an external IPv4 network using a 4in6 tunnel in the IPv6 network;
a DSTM server adapted to manage information on an IPv4 address pool, a domain name corresponding to the IPv4 address pool, and an address of a Tunnel End Point (TEP); and
a TEP/DNSv4 adapted to encapsulate a packet transferred from the IPv4 network and to transmit the packet to the IPv6 network, and to decapsulate the packet transmitted from the IPv6 network via the DSTM client and the DSTM server and to transmit the packet to the IPv4 network.

11. The system according to claim 10, further comprising:
a V4HOST arranged in the IPv4 network and adapted to try to connect to a server within the IPv6 network; and
a DNSv4 adapted to obtain an IPv4 address of the DSTM client via communication with the TEP/DNSv4 and to transmit the obtained IPv4 address to the V4HOST;
wherein the V4HOST is connected to the DSTM client by the TEP/DNSv4 using the obtained IPv4 address.

12. The system according to claim 10, wherein the TEP/DNSv4 includes:
a TEP process adapted to manage TEP data and to process a tunnel message;
a DNSv4 server connected to a V4 domain to perform a V4 domain name process; and
a routing process adapted to set V4 routing and V6 routing.

13. The system according to claim 12, wherein the TEP data is arranged in an IPv4-IPv6 mapping table structure, and includes at least one of information on a V6 address, a V4 address, a host name and a lifetime in each DSTM domain.

14. The system according to claim 10, wherein a Domain Name System (DNS) is set by exchanging a tunnel generation message and a tunnel information message between the DSTM client, the DSTM server and the TEP/DNSv4.

15. The system according to claim 14, wherein the DNS setting comprises:
enabling the DSTM client to transmit a tunnel generation message to the DSTM server;
enabling the DSTM server to load client information and domain name obtained from the tunnel generation message and information including a V4 address selected from a V4 address pool on a new tunnel generation message and to transmit the information to the TEP/DNSv4; and
enabling the TEP/DNSv4 to record the received client information, generate a tunnel information message indicating that tunnel generation has been completed, and to transmit the information message to the DSTM client via the DSTM server.

16. The system according to claim 15, wherein the tunnel generation message transmitted to the DSTM server by the DSTM client includes at least one of information on an IPv6 address, a host name and a domain name of the DSTM client.

17. The system according to claim 15, wherein the tunnel generation message transmitted to the TEP/DNSv4 by the DSTM server includes at least one of information on an IPv6 link-local address, an IPv6 global address, a host name, and a domain name of the DSTM client, and information on the V4 address selected by the DSTM server to be matched with the domain name in the IPv4 address pool.
